(19) United States
(12) Patent Application Publication
(10) Pub. No.: US 2002/0083193 A1
(43) Pub. Date: Jun. 27, 2002

(54) Parallel network data transmission

(76) Inventor: Henry Terefenko, Clifton Park, NY (US)

Correspondence Address: Fish & Richardson P.C., 45 Rockefeller Plaza, Suite 2800, New York, NY, 10111, US

(21) Appl. No.: 09/732,629

(22) Filed: Dec. 8, 2000

Related U.S. Application Data
(60) Provisional application No. 60/245,543, filed on Nov. 3, 2000.

(51) Int. Cl. G06F 15/173

(52) U.S. Cl. 709/238

(57) ABSTRACT

Techniques for obtaining a data stream include requesting multiple sources, each of which contains a copy of the data stream, to send different respective segments of the data stream to a specified destination and dynamically adjusting the relative number of segments of the data stream that each of the sources should subsequently send. The relative number of segments of the data stream that the sources should send can be adjusted repeatedly until the entire data stream is received. The ability to dynamically adjust the number of segments being sent over a particular route can be particularly advantageous in high latency or chaotic networks in which the throughput of various connections may vary and may change with time. The techniques can help improve the speed at which files or other data streams are transferred by optimizing the overall throughput of the system. The techniques also can help reduce bottlenecking.

### RELATED APPLICATIONS

This application is based on U.S. Provisional Patent Application No. 60/245,543, filed on Nov. 3, 2000.

### BACKGROUND

The invention relates to parallel network data transmission.

Demand for broadband content services has increased significantly in recent years. The increase is a result, in part, of the growth of the Internet which has facilitated commercial applications such as telecommuting and electronic commerce as well as widespread use of the World Wide Web (“the Web”) for communicating and accessing information. In addition to high-speed Internet access and electronic mail (“email”) service, businesses and residential users are increasingly demanding access to a range of other broadband services. For example, virtual private networks, externally hosted application services, integrated online business exchanges, Web hosting and video conferencing are becoming important to the success of businesses. Residential users are increasingly adopting emerging broadband services such as interactive television, video-on-demand, Webcams and Webcasting.

A typical routing scenario involves transferring broadband data from a single server to a single client over the Internet. The routing is highly dependent on peering relationships. Furthermore, such data transfers are subject to latencies that can prevent the potential bandwidth and throughput capability of the system from being fully utilized. bandwidth and throughput capability of the system from being fully utilized.

One proposed solution has been to optimize data transfers by caching requested content as close to the location of the client's device as possible, away from the congested core of the network. Edge caching and network delivery techniques, however, are limited because they generally are deployed only at the edge of the geographic market. Therefore, it would be desirable to improve the techniques for delivering high-speed broadband and other data transfers.

### SUMMARY

In general, according to one aspect, a technique for obtaining a data stream includes requesting multiple sources, each of which contains a copy of the data stream, to send different respective segments of the data stream to a specified destination. The technique further includes dynamically adjusting the relative number of segments of the data stream that each of the sources should subsequently send.

Segments of the data stream received from any particular source can be received over a route that differs from routes over which segments of the data stream are received from the other sources. Adjusting the relative number of segments can be based on prior throughputs of respective connections associated with the sources. The relative number of segments of the data stream that the sources should send can be adjusted repeatedly through the life of the transfer.

The respective segments or rate of the data stream received from each source can depend on an array of data, such as a character string or other pattern, that is sent with the request for the data stream. A modified pattern subsequently can be sent to the sources. Additional segments of the data stream can be sent from the sources based on the modified pattern. Preferably, the respective segments of the data stream sent from each source are non-overlapping unless redundancy is desired.

In some implementations, sequential groups of one or more elements in the pattern correspond to sequential segments of the data stream. Each respective group of one or more elements can identify a particular source. The respective positions of the groups within the pattern can indicate which segments of the data stream are to be sent by each particular source.

The acts of modifying the pattern and receiving additional segments of the data stream can be repeated until substantially all segments of the data stream are received. In general, the received segments can be assembled to obtain substantially the entire data stream.

According to another aspect, a technique of providing a data stream includes receiving requests to send respective segments of the data stream to a particular destination over different routes and sending the segments of the data stream over the different routes. Segments of the data stream sent over any particular route differ from segments sent over the other routes. In general, the relative number of segments of the data stream sent over each of the routes can be dynamically adjusted. Character strings or other patterns can be used to identify the data stream segments that should be sent over each of the routes.

Systems and articles of manufacture for implementing the techniques also are disclosed.

Some implementations may include one or more of the following advantages. For example, the ability to dynamically adjust the number or rate of segments that are sent from each source can be particularly advantageous, for example, in high latency or chaotic networks, such as wide area networks (“WANs”), in which the throughput of various connections may vary and may change with time. The technique can help improve the speed at which files or other data streams are transferred. In particular, the techniques can make use of multiple parallel servers storing a specified data stream and can adapt dynamically to changes in the throughput of the various connections to optimize the overall throughput.

The techniques also can help reduce bottlenecking that might otherwise occur, for example, if a data stream were sent over one or more channels using only a single route or connection. Using the techniques described above, if bottlenecking occurs on any particular route, a modified character string can be sent so that the relative number of data stream segments being sent over the particular route is reduced.

The techniques also can be used to dynamically adapt to the availability of additional sources that can deliver the requested data stream as well as the loss of an existing source as a result, for example, of a failed connection.

Other features and advantages will be readily apparent from the following detailed description, the accompanying drawings and the claims.

### BRIEF DESCRIPTION OF THE DRAWINGS

FIG. 1 is a block diagram illustrating an exemplary system in which the invention can be used.

FIG. 2 illustrates geographically dispersed content servers.

FIG. 3 is a flow chart of a method according to the invention.

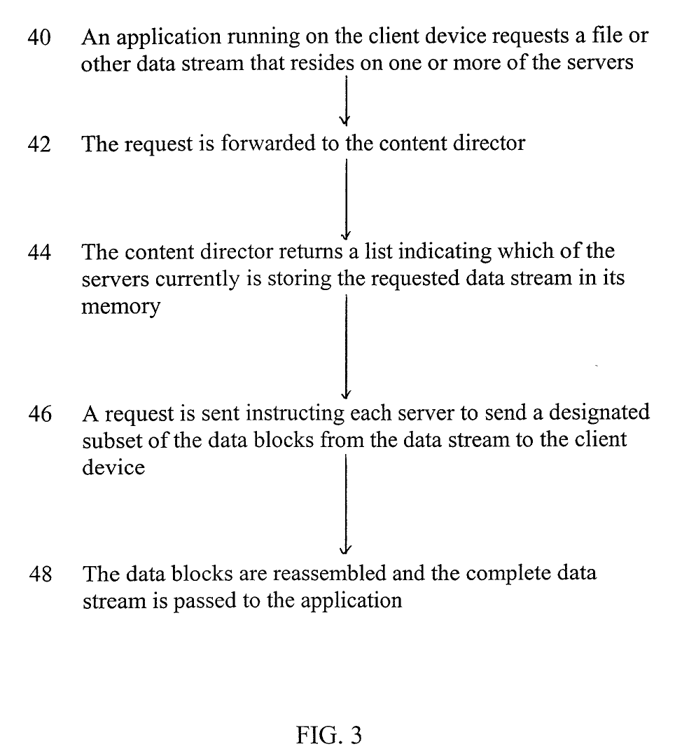

FIG. 4 is a flow chart including a first data stream transfer algorithm executed in connection with a request for a data stream.

FIG. 5 is a flow chart including a second data stream transfer algorithm executed in connection with a request for a data stream.

FIG. 6 illustrates an exemplary pattern.

FIG. 7 illustrates portions of an exemplary data stream.

FIGS. 8 and 9 are flow charts relating to techniques for generating modified patterns.

FIGS. 10A and 10B illustrate exemplary modified pattern.

FIG. 11 is a block diagram illustrating another exemplary system in which the invention can be used.

FIG. 12 illustrates an exemplary pattern.

### DETAILED DESCRIPTION

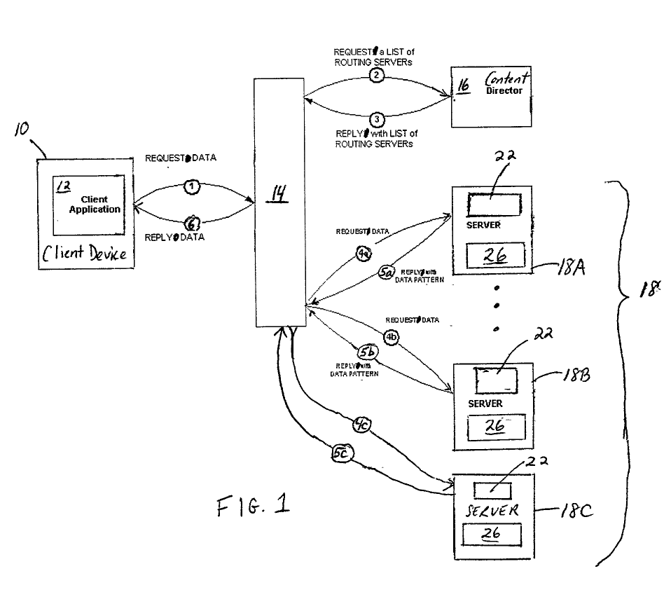

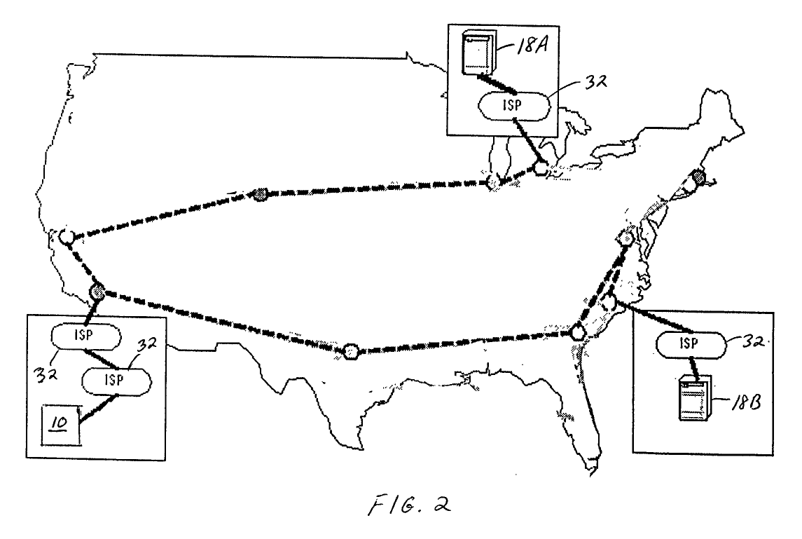

As shown in FIG. 1, a computer system includes a client device 10. Exemplary client devices include personal computers with a modem, workstations and portable computers such as laptop computers, notebook computers and palmtop computers. One or more computer application programs 12 run on the client device 10. A module 14 associated with the client device 10 executes a first data stream transfer algorithm in response to a request from an application program 12 for a particular data stream. The module 14 can interact with a content director server 16 that keeps track of the contents stored on one or more servers 18. Although three servers 18A, 18B, 18C are shown in FIG. 1, the system can include fewer or more than three servers 18. The servers 18 may be geographically or network-topographically dispersed from one another and from the client device 10 as illustrated by FIG. 2. That figure also shows connections between the client 10 and the servers 18 over different routes 28, 30 through a network, such as the Internet, and Internet Service Providers (“ISPs”) 32. Each server 18 includes memory 22 in which the contents of files or other data streams are stored. The contents of a particular server's memory 22 may be, but need not be, the same as the contents of other servers' memories. Each server 18 also has an associated module 26 that executes a second data stream transfer algorithm and responds to requests for data received from the module 14.

In general, an application program 12 running on the client device 10 can request 40 a file or other data stream that resides on one or more of the servers 18. In addition to files, other data streams can include video streams, audio streams, and combinations of video and audio streams. The request is intercepted by the module 14 which forwards 42 the request to the content director server 16. The content director server 16 returns 44 a list indicating which of the servers 18 currently is storing a complete, or substantially complete, copy of the requested data stream in its memory 22. The module 14 then sends 46 a request instructing each server 18 to send a designated subset of the data blocks from the data stream to the client device 10. A transmitted pattern, such as a pattern string, can be used to identify the subsets of data blocks that each server 18 is to send. In general, each server 18 is instructed to transfer data blocks that differ from the blocks being transferred by the other servers. In other words, preferably, every data block in the data stream is sent by one of the servers 18. In many cases, the rates at which the various servers 18 transfer the requested data blocks will not be the same. Furthermore, as discussed below, the relative rates at which the servers 18 transmit data blocks can be changed dynamically. The module 14 reassembles 48 the received data blocks in their proper order in real-time and passes the data stream to the application program 12.

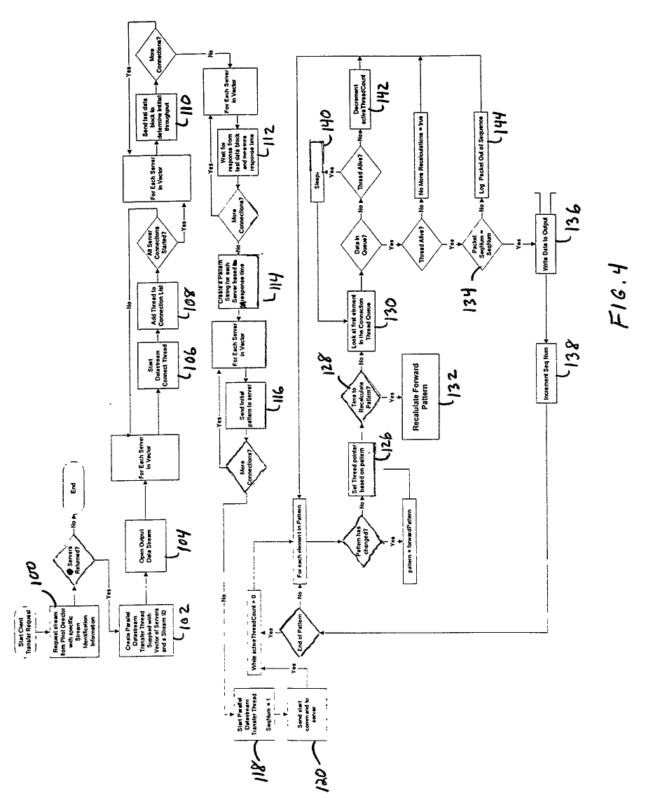

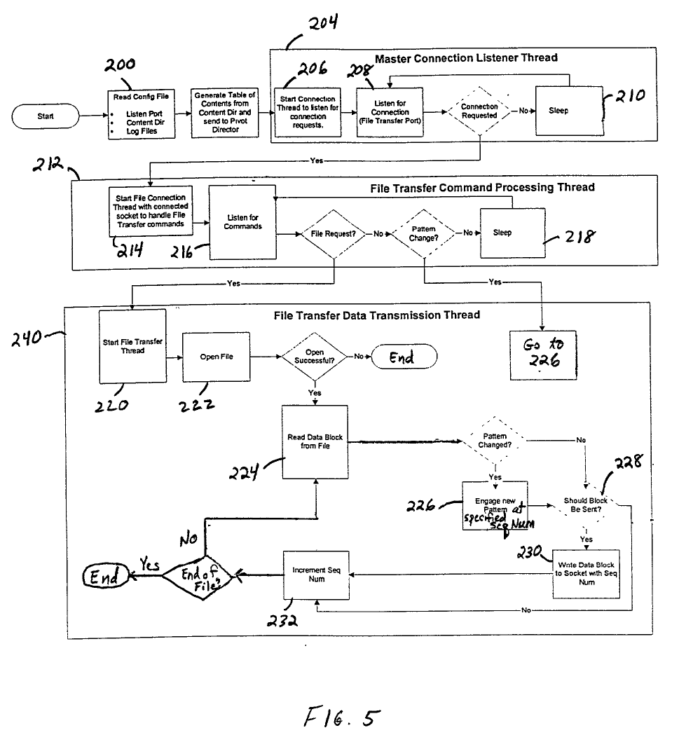

FIGS. 4 and 5 illustrate further details of the process according to one implementation. FIG. 4 is a flow chart that includes an implementation of the first data stream transfer algorithm executed by the module 14 when a client application 12 requests a particular data stream. FIG. 5 includes an implementation of the second data stream transfer algorithm executed by each module 26 in the servers 18.

When power is provided to a server 18, such as the server 18A, the server reads 200 (FIG. 5) a configuration file and identifies an external port for receiving commands or other information. The server 18A also identifies the directory in which the contents reside and where various files or other information is stored. Based on the identified directory, the server 18A generates 202 a table of contents that is sent to the content director server 16. The server 18A then continuously loops through a routine 204 that allows the server to listen for a request for a connection. The routine 204 is initiated 206, and the server 18A listens 208 for a request for an external connection. If a request for a connection is not received, the server 18A enters 210 a sleep mode for a brief period (having, for example, a duration of five milliseconds (ms)) before returning to block 208. If a request for a connection is received, then the process continues with a command processing routine 212. The command processing routine 212 is initiated 214, and the server 18A listens 226 for receipt of commands. Exemplary commands include requests for files or other data streams and changes to the pattern that designates which data blocks in the data stream are to be sent by the various servers 18. If no such commands are received, then the server 18A may enter 2180 a sleep mode (having, for example, a duration of 5 ms) before returning to block 216.

As shown in FIG. 4, when a client application requests a file or other data stream, the module 14 intercepts the request and sends 100 a request for the particular data stream to the content director server 16. The request received by the director server 16 can include information such as the name and size that identifies the requested data stream. If the director server 16 returns a list of one or more servers 18 that contain a copy of the requested data stream, then the module 14 establishes 102 a vector of servers associated with the requested data stream. The vector can include, for example, an Internet Protocol (IP) address, a port and a path for each server 18 in the list returned by the director server 16. The module 14 also opens 104 an output data stream. In the following example, it is assumed that the director server 18 returns a list indicating that three servers 18A, 18B, 18C contain the requested data stream.

For each server 18A, 18B, 18C in the vector established in block 102, the proxy module 14 initiates 106 a routine to open a connection to the server 18. As each connection is established, the connection is added 108 to a connection list maintained by the module 14. The loop formed by blocks 106, 108 continues until a connection is opened to each of the servers 18A, 18B, 18C.

In some implementations, the module 14 sends 110 a test data block or other test message to each server 18A, 18B, 18C. The test block can be used to determine an initial expected throughput that each server 18A, 18B, 18C is capable of providing. Upon receiving the test data block, each server 18A, 18B, 18C returns the block (or some other predetermined message) to the module 14. The module 14 measures 112 the response time for each of the servers 18A, 18B, 18C.

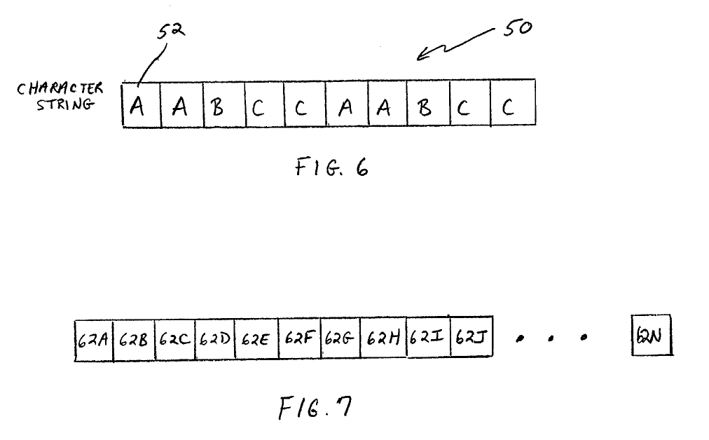

Based on the measured response times, the module 14 generates 114 an initial pattern that is used to identify which data blocks in the requested data stream will be sent from each server 18A, 18B, 18C. The pattern also reflects the relative percentage of data blocks that each server is to send. In general, the number of elements in the pattern can be less than the number of data blocks in the data stream. FIG. 6 illustrates an exemplary pattern 50 having a length of ten elements 52. In this case, each element 52 uniquely identifies a specific data connection from the servers 18A, 18B or 18C. In the example of FIG. 6, the character “A” identifies the connection from server 18A, the character “B” identifies the connection from server B, and the character “C” identifies the connection from server C. Thus, in the pattern 50, the first two elements 52 (starting from the left-side) identify the connection from server 18A, the third element identifies the connection from server 18B, and the fourth and fifth elements identify the connection from server 18C. In this example, the foregoing pattern of characters is repeated through the remainder of the pattern string 50. In general, however, the pattern need not be a repeating one.

After generating the pattern 50, the module 14 sends 116 the initial pattern string to each of the servers 18A, 18B, 18C. The module 14 then begins 118 execution of the first parallel data stream transfer routine. A “sequence number” or other sequencing identifier is used to identify the data blocks in the stream in sequential order. The sequence number initially is set to “1.” The module 14 sends 120 a command to the servers 18A, 18B, 18C to begin sending their respectively designated data blocks for the specified data stream.

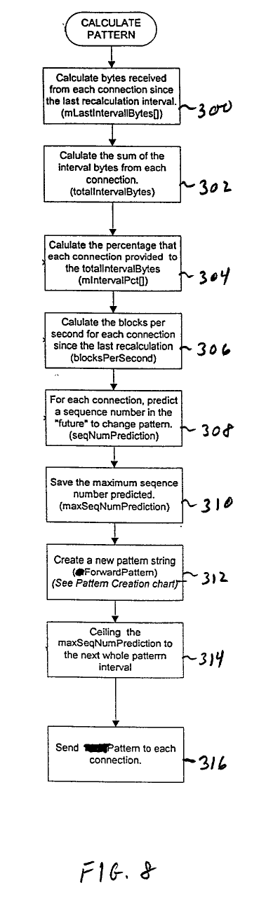

As shown in FIG. 5, when the servers 18A, 18B, 18C, receive the command instructing them to send the specified data stream, each server begins 220 execution of the second data stream transfer routine 240. Each server, such as the server 18A, opens 222 the specified file or other data stream stored in its respective memory 22. Assuming that the data stream is successfully opened, each server 18A, 18B, 18C continuously reads the data blocks in sequence, one block at a time, and based on the corresponding element 52 in the pattern 50, determines whether to send the particular data block to the client device 10. For example, the server 18A would read 224 the first data block 62A (FIG. 7) in the specified data stream 60. As each data block in the stream 60 is considered, the server 18A uses the sequence number (“SeqNum”) to identify the position of the data block within the stream. As discussed in greater detail below, the pattern can be changed dynamically, for example, to improve the overall throughput of the system. Assuming, however, that a new pattern is not received, the server 18A determines 228 whether the first data block 62A should be sent based on the first element 52 in the string. According to the pattern 50 in FIG. 6, the first element “A” identifies the connection from the server 18A. Therefore, the server 18A would write 230 the first data block 62A along with the sequence number to a socket through which the data is to be sent. The server 18A then increments 232 the value of the sequence number by one. If the end of the data stream has not yet been reached, then the process continues with the next data block.

As indicated by the pattern 50 in FIG. 6, the second element “A” also identifies the connection from server 18A. Therefore, the server 18A would write the second data block 62A along with its corresponding sequence number to the socket so that it can be transmitted to client device 10. The server 18A also would increment the value of the sequence number by one. On the other hand, the third, fourth and fifth characters in the pattern 50 identify connection from servers different from the server 18A. Therefore, during the subsequent three cycles of blocks 224 and 228, the next three data blocks 62C, 62D and 62E would not be transmitted by the server 18A. Similarly, based on the pattern 50 in FIG. 6, the server 18A would send the sixth and seventh data blocks 62F, 62G to the client device 10 via the module 14. The eighth, ninth and tenth data blocks 62H, 62I, 62J, however, would not be sent by the server 18A.

The servers 18B, 18C also cycle through process steps 224, 228, 230, 232 (FIG. 5) and determine which data blocks in the stream are to be sent. Using the example of FIGS. 6 and 7, server 18B would send the data blocks 62C, 62H, but not the data blocks 62A, 62B, 62D, 62E, 62F, 62G, 62I and 62J. Similarly, the server 18C would send the data blocks 62D, 62E, 62I, 62J, but not the data blocks 62A, 62B, 62C, 62F, 62G and 62H. Each server 18A, 18B, 18C continues to cycle through that process until it receives a new pattern or until it reaches the last data block 62N in the specified data stream 60.

As the servers 18A, 18B, 18C send their respective designated data blocks to the client device 10 via the module 14, the data blocks received at the client-side of the system form an interleaved data stream and are assembled in their proper order. The module 14 can set 126 a pointer to receive the data blocks from the servers 18 in sequential order. The module 14 can determine which server 18 should have sent each particular data block based on the pattern 50.

Based on an identification of the server 18 that is expected to send the next data block in the sequence, the module 14 looks 130 at the first element in a queue of data received from with the particular server. Assuming that there is data in the queue and the connection to the server is present, the module 14 checks 134 whether the sequence number (“SeqNum”) received with the data block is the same as the sequence number that the module expects. If the sequence number associated with the received data block corresponds to the expected sequence number, the module 14 writes 136 the data block to an output so that the data blocks are assembled in their proper order and can be provided to the application program 12 on the client device 10. The value of the sequence number that the module 14 expects to see for the next data block is incremented 138 by one, and the cycle is repeated for the subsequent data blocks until all the data blocks in the data stream have been received and assembled in their proper sequence. After a particular server 18 sends all its designated data blocks, its connection to the module 14 is terminated.

When the module 14 looks at the first element in the queue for a particular server 18 (block 130), if no data is currently in the queue and the connection is present, the module enters 140 a sleep mode for a brief period (for example, 5 ms), and then rechecks whether data is present. If the connection to the particular server 18 has been terminated, a count of the number of server connections is decremented by one, thereby allowing the module 14 to keep track of the number of connections that have not yet been terminated. Similarly, if (in block 134) the expected sequence number does not match the received sequence number for the data block, the module 14 can generate and store 144 a message in a log that a packet was received out of sequence.

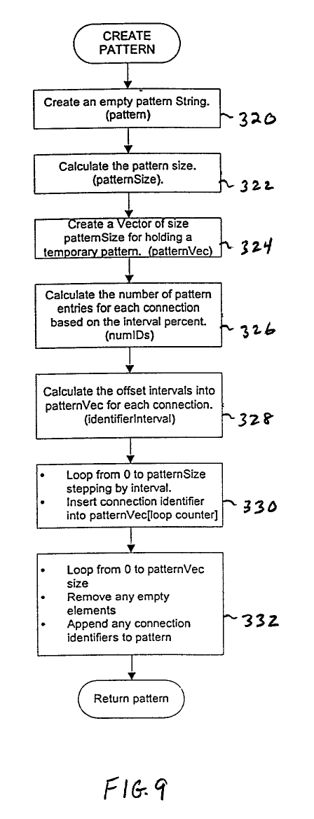

The module 14 also periodically determines 128 whether a new pattern should be generated. In other words, patterns can be generated and implemented dynamically in real-time during transmission of the data stream. New patterns can be generated, for example, to better reflect the actual throughput rates at which the data blocks are being received from the individual servers 18. Similarly, new patterns can be generated to account for additional servers 18 that may become available to supply the requested data stream and to account for servers whose connection to the module 14 has been terminated prematurely, for example, as a result of a failed network connection. In one implementation, a new pattern is generated 132 if the following criteria are satisfied: (1) the previous pattern has been executed at least once, (2) a predetermined time interval has elapsed, and (3) none of the connections to the servers 18A, 18B, 18C has terminated. Further details regarding the calculation of a new pattern are discussed below in connection with FIGS. 8 and 9.

In one exemplary implementation, to generate a new pattern, the module 14 calculates the number of bytes (“mLastIntervalBytes[n]”) received over each connection since the previous recalculation interval. The module 14 also calculates 302 the total number of the bytes (“totalIntervalBytes”) received during that interval. Next, the module 14 calculates 304 the percentage of total bytes (“mIntervalPct[n]”) that each connection provided during the previous interval. That can be determined by dividing the results obtained in block 300 by the result obtained block 302. The module also calculates 306 the number of blocks per second (“blocksPerSecond”) that were received over each connection since the previous interval. For each connection, the module predicts 308 a sequence number (“seqNumPrediction”) with respect to which the new pattern string should be executed based on a future time (“secondsInFuture”). For example, the predicted sequence number for a connection (“n”) can be calculated according to the following equation:

SeqNumPrediction[n]=

$$\frac{( blocksPerSecond * secondsInFuture )}{ mIntervalPct [ n ]} + lastSeqNum ,$$

where “lastSeqNum” is the sequence number of the most recent data block received over the particular connection. The value of the highest predicted sequence number (“maxSeqNumPrediction”) is saved 310, and an updated pattern (“ForwardPattern”) is generated 312. Further details for generating an updated pattern according to one exemplary implementation are discussed below in connection with FIG. 9. Preferably, the updated pattern is rounded 314 upward to the nearest whole pattern interval by setting

$$maxSeqNumPrediction = \frac{( maxSeqNumPrediction + patternSize )}{patternSize} * patternSize ,$$

where “patternSize” is the number of elements in the pattern. The updated pattern then is sent 316 along with the calculated value “maxSeqNumPrediction” to each of the servers 18A, 18B, 18C. The servers 18 receive the updated pattern and apply (block 126, FIG. 5) the updated pattern starting with the data block whose sequence number is equal to “maxSeqNumPrediction.”

FIG. 9 illustrates one implementation for modifying the updated pattern, although other techniques can be used as well. Initially, an empty pattern is created 320 and the size of the pattern (“patternSize”) is selected 322. In general, the larger the size of the pattern, the greater the resolution. The size of the updated pattern can be larger, smaller or the same as the size of the initial pattern. A vector having a size equal to the size of the updated pattern is established 324. The number of entries (“numIDs”) in the pattern that correspond to each server 18 is determined 326 based on the percentage of total bytes (“mIntervalPct[n]”) that each connection provided during the previous interval. For example, the number of elements (numIDs[n]”) in the pattern associated with a particular server can be calculated as follows:

$$numIDs [ n ] = \frac{mIntervalPct [ n ] * patternSize}{100} .$$

Next, the distance (“identifierInterval[n]”) between entries in the pattern that correspond to a particular server is determined 328, for example, as follows:

$$identifierInterval [ n ] = \frac{patternSize}{numIDs [ n ]} = \frac{100}{mIntervalPct [ n ]} .$$

The elements are inserted 330 into the vector established in block 324 based on the calculated intervals (“identifierInterval[n]”), and any empty elements in the vector are removed 332 to complete the updated pattern.

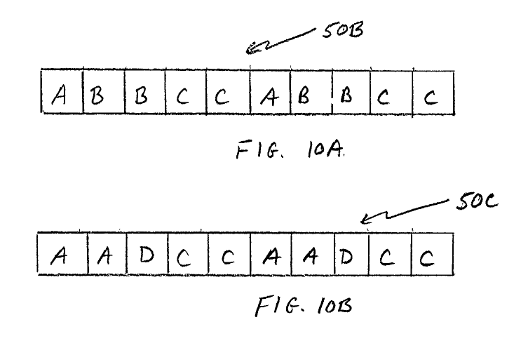

An exemplary updated pattern 50A is illustrated in FIG. 10A. The pattern 50A may reflect a situation in which the average relative throughput of data blocks from the server 18A has decreased and the average relative throughput of data blocks from the server 18B has increased. When the servers 18 begin to apply the updated pattern 50A (starting with the data block specified by the module 14), the relative rate at which each server 18 is sending data blocks will be modified in accordance with the updated pattern. For example, assuming that the updated pattern is to be applied starting with the data block corresponding to the sequence number fifty, then the server 18A would the send data block corresponding to the sequence number fifty, the server 18B would send the data blocks corresponding to the sequence numbers fifty-one and fifty-two, and the server 18C would send the data blocks corresponding to the sequence numbers fifty-three and fifty-four. The updated pattern would be used either until the end the last data block in the data stream is reached or until a new pattern is supplied by the module 14.

As previously mentioned, the updated pattern also can reflect the fact that a connection to one of the servers has failed and/or that another server is available to provide the requested data stream. For example, the director server 16 may become aware that another server (not shown) is powered up and has a copy of the requested data stream. The director server 16 can supply that information to the module 14 which can request specified data blocks from the additional server. An exemplary updated pattern 50B is shown in FIG. 10B where it is assumed that the connection to the server 18C no longer is present or that its throughput was too low. It further is assumed that the additional server (identified by the character “D”) is available and that a connection is established to the additional server. When the servers 18 begin to apply the updated pattern 50B, each server will send data blocks in accordance with the updated pattern (starting with the data block specified by the module 14).

For example, assuming that the updated pattern 50B is to be applied starting with the data block corresponding to the sequence number fifty, then the server 18A would send data blocks corresponding to the sequence numbers fifty and fifty-one, the additional server (not shown) would send the data block corresponding to the sequence number fifty-two, and the server 18C would send the data blocks corresponding to the sequence numbers fifty-three and fifty-four. The updated pattern would be used either until the end the last data block in the data stream is reached or until a new pattern is supplied by the module 14.

Various modifications which will be readily apparent to one of ordinary skill can be made to the foregoing implementations. In some cases, the module 14 can determine which servers 18 contain the requested data stream without receiving a list of such servers from the director server 16. For example, the client device 10 may already be aware of specific servers 18 that contain the requested data stream. Alternatively, the module 14 initially can broadcast a message to all the servers 18 requesting the specified data stream. Based on the responses (or lack of responses) from the servers 18, the module would determine which servers contained a copy of the requested data stream.

Furthermore, in the foregoing discussion it was assumed that each character in the pattern corresponds to a single data block. In other implementations, each element in the pattern can correspond, instead, to some other predetermined segment of the requested data stream, such as a single byte. Similarly, in some implementations, multiple elements in the pattern can correspond to a single segment.

In addition, sequence identifiers other than sequential numbers can be used to identify the proper sequence of the data blocks. Similarly, techniques such as time domain multiplexing can be used to send the data blocks to the module 14. The module 14 would then assemble the data blocks in their proper order to obtain the complete requested data stream based on the time frame in which each data block was received.

As discussed above, the future prediction of when the updated pattern should be applied by the servers 18 can be performed in an asynchronous manner. However, in other implementations, it can be performed in a synchronous manner.

The ability to dynamically adjust the pattern can be particularly advantageous, for example, in high latency or chaotic networks, such as wide area networks (“WANs”), in which the throughput of various connections may vary and may change with time. The technique can help improve the speed at which files or other data streams are retrieved. In particular, the techniques described above can make use of multiple parallel servers storing a specified data stream and can adapt dynamically to changes in the throughput of the various connections to optimize the overall throughput.

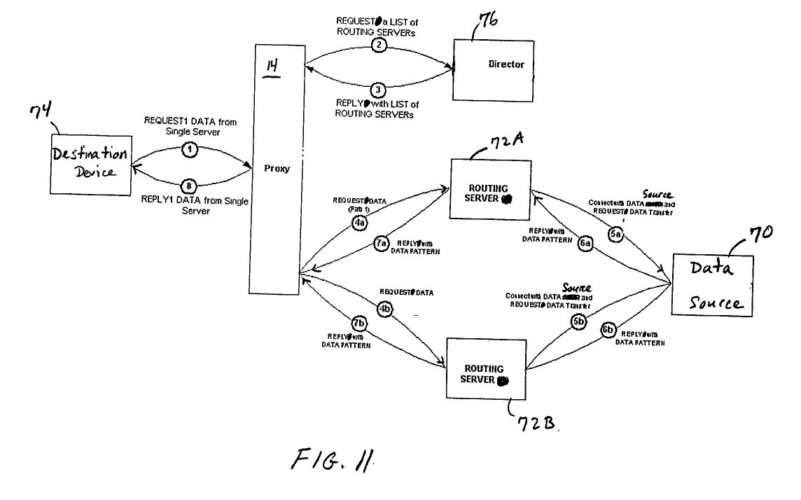

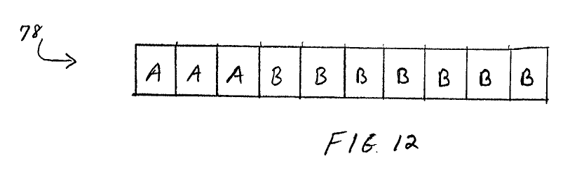

As illustrated in FIG. 11, some of the techniques described above also can be applied to transfer a requested data stream from a single source 70 to a destination device 74 by way of multiple routing servers 72A, 72B. For example, a person can request a particular video, audio or other data stream from the source 70 using a destination device 74, such as a television or a personal computer. The request is intercepted by the module 14 which forwards the request to a director server 76. The director server 76 returns a list identifying available routes connecting the source 70 and the destination device 74 and identifying the servers 72A, 72B along those routes. Connections are established between the destination device 74 and the routing servers 72A, 72B. The module 14 then sends a request instructing each server 72A, 72B to obtain and send designated segments of the data stream. As previously discussed, a pattern can be used to identify the segments that each server 72A, 72B is to send. An exemplary pattern 78 is shown in FIG. 12, where the character A indicates that the corresponding data stream segment should be sent along the route that includes the server 72A, and the character B indicates that the corresponding data stream segment should be sent along the route that includes the server 72B.

Each server 72A, 72B forwards the received request for the data stream along with the pattern to the source 70. The source 70 then sends the requested segments of the data stream to the individual servers 72A, 72B based upon the pattern. For example, using the pattern shown in FIG. 12, the source 70 would send the first, second and third data stream segments along the route that includes the server 72A. The fourth through tenth segments would be sent along the route that includes the server 72B. Subsequent segments of the data stream are sent using that pattern until the end of the data stream is reached or until a modified pattern is received and implemented. In other words, the relative number or percentage of data stream segments transmitted over the different routes by way of the respective associated servers 72A, 72B can be changed dynamically by sending a modified pattern as previously described.

Each segment of the data stream can be sent with a sequence number or other identifier that indicates the position of the segment within the stream. Upon receiving the data blocks, the module 14 reassembles them in their proper order and passes the data stream to the destination device 74. Modifying the pattern and assembling the segments can be performed, for example, in real-time.

The technique illustrated by FIG. 11 can help reduce bottlenecking that might otherwise occur, for example, if the data stream were sent over one or more channels on only a single route. Using the techniques described above, if bottlenecking occurs on any particular route, a modified pattern can be sent by the module 14 so that the relative number of data stream segments being sent over the particular route is reduced.

Various features of the system 20 can be implemented in hardware, software, or a combination of hardware and software. For example, some aspects of the system can be implemented in computer programs executing on programmable computers. Each program can be implemented in a high level procedural or object-oriented programming language. Furthermore, each such computer program can be stored on a storage medium, such as read-only-memory (ROM), readable by a general or special purpose programmable computer, for configuring and operating the computer when the storage medium is read by the computer to perform the functions described above.

Other implementations are within the scope of the claims.

What is claimed is:

1. A method of obtaining a data stream comprising:
requesting a plurality of sources, each of which contains a copy of the data stream, to send different respective segments of the data stream to a specified destination; and
dynamically adjusting the relative number of segments of the data stream that each of the sources should subsequently send.

2. The method of claim 1 wherein segments of the data stream received from any particular source are received over a route that differs from routes over which segments of the data stream are received from other ones of the sources.

3. The method of claim 1 including receiving additional respective segments of the data stream from the sources after adjusting the relative number of segments to be sent by each source, wherein the additional received segments represent at least part of a portion of the data stream not previously received in response to the request.

4. The method of claim 3 wherein adjusting the relative number of segments is based on prior throughputs of respective connections associated with the sources.

5. The method of claim 1 including repeatedly adjusting the relative number of segments of the data stream that the sources should send.

6. The method of claim 5 including assembling the received segments to obtain substantially the entire data stream.

7. The method of claim 1 wherein at least some segments of the data stream are received over a high latency network.

8. A method of obtaining a data stream comprising:
requesting a plurality of sources, each of which contains a copy of the data stream, to send different respective segments of the data stream and sending a first pattern to each of the sources;
receiving the different respective segments of the data stream from the sources, wherein the respective segments of the data stream received from each source depend on the first pattern;
sending a modified pattern to the sources during receipt of the respective segments of the data stream from the sources; and
receiving additional different respective segments of the data stream from the sources based on the modified pattern.

9. The method of claim 8 including calculating the modified pattern based on prior throughputs of connections to the sources.

10. The method of claim 9 including repeatedly modifying the pattern and receiving additional different respective segments of the data stream until substantially all segments of the data stream are received.

11. The method of claim 10 including assembling the received segments to obtain substantially the entire data stream.

12. The method of claim 8 wherein the respective segments of the data stream are non-overlapping.

13. The method of claim 8 wherein sequential groups of one or more elements in the pattern correspond to sequential segments of the data stream.

14. The method of claim 13 wherein each segment comprises a data block.

15. The method of claim 8 wherein respective groups of one or more elements in the pattern identify respective particular ones of the sources, and wherein the respective positions of the groups within the pattern indicate which segments of the data stream are to be sent by each particular source.

16. A method of providing a data stream comprising:
receiving requests to send respective segments of the data stream to a particular destination over different routes; and
sending the segments of the data stream over the different routes, wherein segments of the data stream sent over any particular route differ from segments sent over other ones of the routes.

17. The method of claim 16 including dynamically adjusting the relative number of segments of the data stream sent over each of the routes.

18. The method of claim 16 including receiving a pattern associated with the requests, wherein the pattern identifies the particular segments to be sent over the different routes.

19. The method of claim 18 wherein the pattern includes groups of one or more element, each group identifying a particular one of the routes, and wherein respective positions of element groups within the pattern that correspond to a particular route identify which segments of the data stream are to be sent along the particular route.

20. The method of claim 19 including determining whether individual segments of the data stream should be sent along the particular route, wherein the individual segments are considered in a predetermined sequential order.

21. The method of claim 16 including repeatedly adjusting the relative number of segments the data stream that should be sent over each of the routes.

22. The method of claim 16 including receiving the segments sent over the different routes and assembling the received segments to obtain substantially the entire data stream.

23. A system for transferring a data stream comprising:
a device capable of executing an application program;
a module associated with the device and configured to intercept a request for the data stream generated by the application program; and
a plurality of sources each storing a copy of the data stream;
wherein the module is configured to request each of the sources to send different respective segments of the data stream and, prior to receiving all segments of the data stream, to adjust dynamically the relative number of segments of the data stream that each of the sources should send.

24. The system of claim 23 wherein the module is configured to adjust the relative number of segments to be sent by the sources based on prior throughputs of respective connections associated with the sources.

25. The system of claim 23 wherein the module is configured to repeatedly adjust the relative number of segments of the data stream that the sources should send.

26. The system of claim 23 wherein the module is configured to assemble the received segments into substantially the entire data stream and to transfer the data stream to the application program.

27. The system of claim 23 wherein the module is configured to send a first pattern to the sources to identify the segments that each source initially should send, and wherein the module is further configured to send another pattern to indicate the adjusted relative number of segments of the data stream that the sources should send.

28. The system of claim 27 wherein each pattern includes groups of one or more elements, each group identifying a particular one of the sources, and wherein respective positions of element groups within a particular pattern that correspond to the particular source identify which segments of the data stream are to be sent by the particular source.

29. The system of claim 23 wherein the segments sent by the sources are non-overlapping.

30. A system for transferring a data stream comprising:
a destination device;
a module associated with the destination device and configured to intercept a request for the data stream generated by the destination;
a source of a data stream; and
a plurality of servers located along different routes that can couple the destination device to the source;
wherein the module is configured to request each of the servers to route different respective segments of the data stream to the destination device and, prior to receiving all segments of the data stream, to adjust dynamically the relative number of segments of the data stream that each of the servers should route.

31. The system of claim 30 wherein the servers are configured to route the request to the source, and wherein the source is configured to send the segments of the data stream over the different routes in response to the requests from the servers, wherein segments of the data stream sent over any particular route differ from segments sent over other ones of the routes.

32. The system of claim 31 wherein the module is configured to adjust the relative number of segments to be routed through the servers based on prior throughputs of the routes associated with the servers.

33. The system of claim 30 wherein the module is configured to repeatedly adjust the relative number of segments of the data stream to be routed through the servers.

34. The system of claim 30 wherein the module is configured to assemble received segments into substantially the complete data stream and to transfer the data stream to the destination device.

35. The system of claim 30 wherein the module is configured to send a first pattern to the servers to identify the segments that should initially be sent over the routes, and wherein the module is further configured to send another pattern to identify the adjusted relative number of segments of the data stream that the should be sent over the routes.

36. The system of claim 35 wherein each pattern includes groups of one or more elements, each group identifying a particular one of the routes, and wherein respective positions of element groups within a particular pattern that correspond to the particular routes identify which segments of the data stream are to be sent over the particular source.

37. An article comprising a computer-readable medium that stores computer-executable instructions for causing a computer system to:
request a plurality of sources, each of which contains a copy of a data stream, to send different respective segments of the data stream; and
prior to receiving all segments of the data stream, dynamically adjust the relative number of segments of the data stream that each of the sources should subsequently send.

38. The article of claim 37 including instructions for causing the computer system to adjust the relative number of segments based on prior throughputs of respective connections associated with the sources.

39. The article of claim 37 including instructions for causing the computer system to repeatedly adjust the relative number of segments of the data stream that the sources should send.

40. The article of claim 39 including instructions for causing the computer system to assemble the received segments to obtain substantially the complete data stream.

41. An article comprising a computer-readable medium that stores computer-executable instructions for causing a computer system to:
send segments of a data stream from a particular source containing a copy of the data stream in response to a request for the segments based on a first pattern; and
send additional segments of the data stream from the particular source in accordance with a modified pattern,
wherein segments of the data stream are sent in accordance with the first pattern at least until receipt of the modified pattern.

42. The article of claim 41 wherein each pattern includes groups of one or more elements, each group identifying a particular one of a plurality of sources for the data stream, and wherein respective positions of element groups within the pattern that correspond to the particular source identify which segments of the data stream are to be sent by the particular source.

43. The article of claim 42 including instructions for causing the computer system to determine whether individual segments of the data stream should be sent from the particular source, wherein the individual segments are considered in a predetermined sequential order.

44. An article comprising a computer-readable medium that stores computer-executable instructions for causing a computer system to:
send segments of a data stream to a particular destination over different routes in response to requests for the segments, wherein segments of the data stream sent over any particular route differ from segments sent over other ones of the routes; and
dynamically adjust the relative number of segments of the data stream sent over each of the routes.

45. The article of claim 44 including instructions for causing the computer system to send the segments based on a received pattern, wherein the pattern identifies the particular segments to be sent over the different routes.

46. The article of claim 45 wherein the pattern includes groups of one or more elements, each group identifying a particular one of the routes, and wherein respective positions of element groups within the pattern that correspond to a particular route identify which segments of the data stream are to be sent along the particular route.

47. The article of claim 46 including instructions for causing the computer system to determine whether individual segments of the data stream should be sent along the particular route, wherein the individual segments are considered in a predetermined sequential order.

48. The article of claim 44 including instructions for causing the computer system to repeatedly adjust the relative number of segments the data stream that should be sent over the different routes.
